(19) United States
(12) Patent Application Publication
(10) Pub. No.: US 2016/0251598 A1
(43) Pub. Date: Sep. 1, 2016

(54) Candle

(71) Applicants: Pere Sallent Puigcercos, Barcelona (ES); Josep Vila Masllorens, (US)

(72) Inventors: Pere Sallent Puigcercos, Barcelona (ES); Josep Vila Masllorens, (US)

(21) Appl. No.: 14/978,516

(22) Filed: Dec. 22, 2015

(30) Foreign Application Priority Data
Dec. 23, 2014 (ES) ES201431669U

(51) Int. Cl. C11C 5/00

(52) U.S. Cl. CPC C11C 5/008; C11C 5/006

(57) ABSTRACT

A candle; having a wax or paraffin body, and an internal wick; said body having an external tubular part with an orifice for receiving an internal part carrying the wick. The internal part is made out of a laminar element of wax rolled up around the wick and having in at least one of its faces a writing surface aimed at receiving writings by means of a pointed object, the writing surface having a wax or paraffin layer of a colour which is different than the colour of the laminar element.

### SUBJECT OF THE INVENTION

The subject of the invention is a candle having a wax or paraffin body with an internal wick, being said body formed by a tubular part with an orifice for housing a laminar rolled element carrying the wick of the candle.

The candle has features aimed at permitting the incorporation inside of the same of the text of a message or desire to be burned during the consumption of the candle, without using paper, parchment or any other material different than the body of the candle.

### FIELD OF THE INVENTION

The candle will be preferably applicable, although not in a limiting way, in religious or esoteric activities, spiritual therapies, celebrations, for example celebrations for newborns, weddings, birthday parties, Valentine's Day, etc . . . in order to convey a petition or desire.

### STATE OF THE ART

As state of the art the previous existence of the utility model U201030273, has to be mentioned. Said registration belongs to one of the applicants of the present registration and concerns a candle with a feature aimed at facilitating the complete incineration, in a comfortable and simple way, of small laminar elements such as pieces of paper or parchment bearing written or printed texts such as is usual in different fields such as those with a traditional religious character or others.

The candle which is the subject of said previous registration U201030273, comprises a body of wax or similar having internally a lengthwise wick protruding from the upper end of the candle to permit to be ignited. The candle assembly comprises and external tubular body made of wax or similar having an orifice for the introduction and coupling of the candle itself, having said body of the candle, in an intermediate area, a perimetric recess for locating the laminar element to be burned, possibly consisting in a piece of parchment, paper or other material, bearing a written petition or desire.

The incorporation in the candle of an additional material, whether paper, parchment or similar bearing the desire or petition brings about various drawbacks, among which are to be mentioned: the need to supply and handle a different material, and also that said paper or parchment material produces around the wick a second flame, substantially modifying the aspect of the ignited candle.

### DESCRIPTION OF THE INVENTION

The candle subject of the invention corresponds to the above mentioned type, having features aimed at permitting to dispense with the pieces of parchment, paper or other material, different than the body of the candle, permitting notwithstanding to include in the material of the candle the text of the desire or petition in question. In this way, the use of additional materials is prevented, avoiding that these may provoke during its combustion a second flame modifying the traditional aspect of an ignited candle.

The candle which is the subject of this invention has features aimed at permitting the writing of a message or desire in the above mentioned laminar element, which has a thin layer of a different colour extending at least to one of its faces, to facilitate the writing on it with a pointed object, exposing the original colour of the laminar element; so that after having rolled up the laminar element bearing the text of the message or desire, it is incorporated inside the orifice of the tubular body, resulting in a compact piece of candle, which will burn out uniformly.

The candle which is the subject of the present invention, consisting in a body of wax, paraffin or other similar material, suitable for the manufacture of candles, and having the body of the candle an external tubular part with and orifice for housing a laminar rolled element bearing the wick, has the peculiarity that said internal part is comprised of a wax or paraffin laminar element rolled around the wick of the candle and having on at least one of its faces a writing surface with a wax or paraffin layer of a different colour than that of the laminar rolled element.

As a consequence of these features, after the user having written with a pointed object on the wax lining having a different colour than that of the rolled up laminar element, the writing will be visible due to the different colour of the laminar element in respect to the colour of the lining.

By rolling up the laminar element on the wick of the candle the written message is incorporated on said laminar element without the need to use different materials than the wax, paraffin or additives used in the manufactures of the candle. After its rolling up, the laminar element will be located within the orifice of the tubular part, the candle adopting the structure of a compact unique part.

In an embodiment of the invention the wick of the candle will have in its end protruding from the body of the candle a small quantity of gunpowder, to confer a brief effect of sparks at the moment of igniting the candle.

### DESCRIPTION OF THE FIGURES

To complete the description and to facilitate the understanding of the invention, a set of drawings is annexed to the present description to illustrate the invention in a non-limiting form, showing as follows:

FIG. 1, a perspective view of an embodiment of the candle of the invention.

FIG. 2, a perspective view of the candle of FIG. 1, disassembled, during the rolling up around the wick of the candle of the laminar element aimed at forming the internal part of the body of the candle.

FIG. 3, a cross section of a portion of the laminar element with a different colour in one face, by means of a lining of max applied on one of the sides of said laminar element, forming a writing surface.

FIG. 4, a perspective view from an end of the wick having a small gunpowder head.

### PREFERRED EMBODIMENT OF THE INVENTION

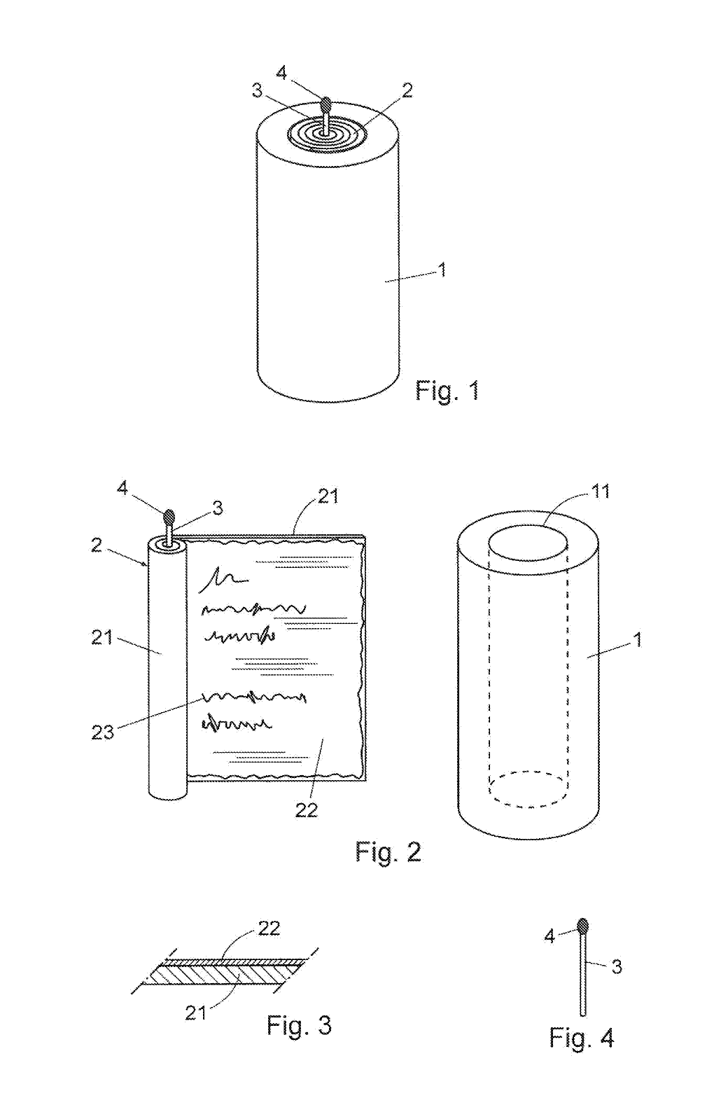

In the example shown in FIG. 1 is to be observed that the body of the candle is formed by an external tubular part (1) with an orifice (11) for closely housing an internal part (2) to support the wick (3).

As is to be observed in FIG. 2, the internal part (2) is formed starting from a laminar element of wax (21) aimed to be wound up around the wick (3), this latter having a small gunpowder head (4). The laminar element has in one of its faces a surface for writing (22) with a lining of wax which has a different colour than the laminar rolled up element (21).

As can be observed from FIG. 2, when writing by means of a pointed object or similar element on the writing surface (22), the lining of wax with a different colour than the laminar element (21) will be removed, defining the characters (23) on said writing surface (22).

In FIG. 3 is to be seen a cross section of laminar element (1) with the surface (22) to receive the writing having a different colour.

In FIG. 4 a detail can be observed showing a cross section of the wick (3) with the head (4) of gunpowder on the end.

After having sufficiently described the nature of the invention, as well as a preferred example of one embodiment of the same, it is stated to all effects that the materials, shape, size and arrangement having been described can be modified provided that the changes do not mean an alteration of the essential features of the invention which are claimed in the following.

1. A candle, having a wax or paraffin body and an internal wick (3); said body comprising an external tubular part (1) with an orifice (11) for housing an internal part (2) supporting the wick (3); characterized in that the internal part (2) is formed by a laminar wax element (21), rolled up around the wick (3), and having at least on one of its faces a writing surface (22) to be written by means of a pointed object, which written surface has a lining of wax or paraffin of a different colour than the laminar element (21).

2. A candle, according to claim 1, characterized in that the internal wick (3) has in its end protruding from the body of the candle a small gunpowder head (4).
